(19) United States
(12) Patent Application Publication
(10) Pub. No.: US 2007/0119129 A1
(43) Pub. Date: May 31, 2007

(54) Dust collecting apparatus of vacuum cleaner

(75) Inventor: Kyoung-hui Jeon, Chungcheongnam-do (KR)

Correspondence Address: Paul D. Greeley;Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD.

(21) Appl. No.: 11/473,784

(22) Filed: Jun. 23, 2006

(30) Foreign Application Priority Data
Oct. 28, 2005 (KR) 10-2005-0102614

(51) Int. Cl. B01D 50/00

(52) U.S. Cl. 55/337

(57) ABSTRACT

A dust collecting apparatus of a vacuum cleaner, the apparatus includes a dust receptacle to collect dust, and a cyclone part inserted in the dust receptacle. The cyclone part guides the drawn-in air vertically through a center of the cyclone part, allows the drawn-in air to flow in a tangential direction inside of the dust receptacle simultaneously from a plurality of directions into the dust receptacle and centrifugally separates the dust from the drawn-in air to discharge along the center.

### CROSS-REFERENCE TO RELATED APPLICATIONS

This application claims benefit under 35 U.S.C. § 119 (a) of Korean Patent Application No. 2005-102614 filed on Oct. 28, 2005, the entire content of which are incorporated herein by reference.

### BACKGROUND OF THE INVENTION

1. Field of the Invention

The present invention relates to a vacuum cleaner. More particularly, the present invention relates to a dust collecting apparatus that separates and collects dusts from drawn-in air.

2. Description of the Related Art

Generally, a vacuum cleaner draws in dust-laden air from a cleaning surface and separates dust from the drawn-in air to clean the surface. The vacuum cleaner includes a dust collecting apparatus to separate dust from the drawn-in air and collect the dust.

Recently, a cyclone dust collecting apparatus has been developed that separates dust from drawn-in air using a centrifugal force. The cyclone dust collecting apparatus has been popularized since it can be sanitarily used for a permanent lifespan in comparison with a conventional dust bag.

International Patent Publication No. WO 01/07168 and Canadian Patent Publication No. CA2330801 disclose the conventional cyclone dust collecting apparatus. The conventional cyclone dust collecting apparatus is formed in a cleaner body and has a structure in which dust-laden air is drawn along a suction nozzle and a suction pipe into a dust receptacle, and air is separated from dust by a centrifugal force and discharged via a discharge pipe and a vacuum motor to the outside of the cleaner.

The conventional dust collecting apparatus has a single inlet pipe that extends from a top end of the suction pipe and faced with a predetermined curvature toward an inside of the dust receptacle to exert a centrifugal force on air drawn in via the suction pipe.

As air is vertically and upwardly drawn in along the suction pipe, it collides with an inner wall of the inlet pipe and the direction of air is suddenly changed. Then, air collides with the inner wall of the dust receptacle while flowing via the single inlet pipe into the dust receptacle so that a pressure is greatly lost. The loss of pressure is generated when drawn-in air rapidly flowing through the suction pipe passes the single inlet and the flowing direction is concentrated on one point. The conventional cyclone dust collecting apparatus having a single inlet has difficulty in preventing the loss of pressure.

Additionally, dust discharged via the single inlet is not evenly distributed and flows continuously only from one direction. Therefore, it is difficult to evenly distribute the dust along a circumferential direction of the dust receptacle and the whole separation efficiency of dust is decreased.

### SUMMARY OF THE INVENTION

The present invention has been conceived to solve the above-mentioned problems occurring in the prior art, and an aspect of the present invention is to provide a dust collecting apparatus that can reduce a loss of pressure generated in a dust receptacle when drawn-in air flows into the dust receptacle.

Another aspect of the present invention is to provide a dust collecting apparatus that evenly distributes drawn-in air in a plurality of directions when air flows into a dust receptacle so that a separation efficiency of dust included in the drawn-in air can be enhanced.

In order to achieve the above aspects, there is provided a dust collecting apparatus of a vacuum cleaner, which is installed into a vacuum cleaner body to centrifugally separate dust from drawn-in air, the apparatus including a dust receptacle to collect the dust, and a cyclone part inserted in the dust receptacle. The cyclone part guides the drawn-in air vertically through a center of the cyclone part, allows the drawn-in air to flow in a tangential direction inside of the dust receptacle simultaneously from a plurality of directions into the dust receptacle and centrifugally separates the dust from the drawn-in air to discharge along the center.

The cyclone part may include a suction passage vertically penetrating a lower portion of the dust receptacle to guide air drawn in via a suction nozzle of the vacuum cleaner from the lower portion to an upper portion, a plurality of inlets disposed at an upper portion of the suction passage to guide the drawn-in air flowed along the suction passage into the dust receptacle, a grille part disposed to enclose the suction passage to flow in air discharged from the plurality of inlets and separated from the dust and prevent the dust from discharging, and a discharge passage connected with the grille part in a fluid-communication to guide air passing the grille part to a vacuum source.

The plurality of inlets may be arranged at same angles based on the center of the suction passage.

The cyclone part may further include a plurality of guides spirally extended from each of leading ends of the plurality of inlets. The plurality of guides may be downwardly formed from one side to the other side of each inlet.

The dust collecting apparatus may further include a skirt formed along a lower end of the grille part to prevent the dust collected in the dust receptacle from re-ascending.

### BRIEF DESCRIPTION OF THE DRAWINGS

The above and other aspects, features and advantages of the present invention will become more apparent and more readily appreciated from the following detailed description of the embodiment taken with reference to the accompanying drawings of which:

FIG. 1 is a perspective view illustrating a cyclone part of a dust collecting apparatus of a vacuum cleaner according to an exemplary embodiment of the present invention; and

FIG. 2 is a longitudinal-sectional view of a cyclone dust collecting apparatus according to an exemplary embodiment of the present invention.

### DETAILED DESCRIPTION OF THE EXEMPLARY EMBODIMENTS

Exemplary embodiments of the present invention will be described in detail with reference to the annexed drawings. In the drawings, the same elements are denoted by the same reference numerals throughout the drawings. In the following description, detailed descriptions of known functions and configurations incorporated herein have been omitted for conciseness and clarity.

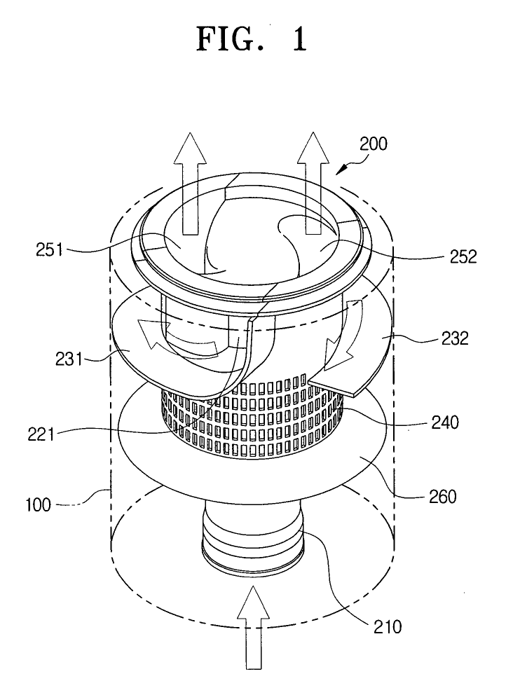

As shown in FIG. 1, a dust collecting apparatus according to an exemplary embodiment of the present invention comprises a dust receptacle 100 and a cyclone part 200 detachably inserted in the dust receptacle 100.

The dust receptacle 100 may be configured as a cylinder so that drawn-in air flowing from the cyclone part 200 can freely rotate in the dust receptacle 100.

The cyclone part 200 exerts a centrifugal force on drawn-in air by a vacuum source (not shown) to separate a dust from the drawn-in air in the dust receptacle 100.

The cyclone part 200 has at a center a suction passage 210 that penetrates a lower portion of the dust receptacle 100 to be vertically disposed. The suction passage 210 has a bottom end that is directly connected with a suction nozzle (not shown) that is in fluid communication or connected with a flexible hose (not shown), which is in turn connected with the suction nozzle so as to guide the drawn-in air upwardly.

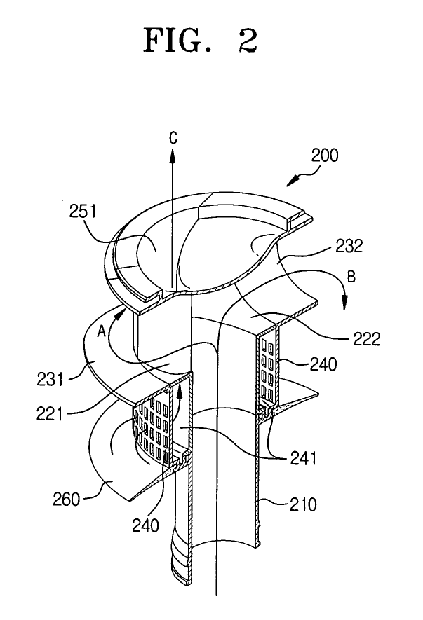

At an upper end of the suction passage 210, two inlets 221 and 222 (refer to FIG. 2) are formed oppositely to each other and perpendicularly to the suction passage 210 so that the drawn-in air upwardly guided along the suction passage 210 can flow into the dust receptacle 100.

Two guides 231 and 232 are spirally extended from the cyclone part 200. Guides 231 and 232 extend from inlets 221 and 222, respectively, to exert a centrifugal force so that dust can be separated from the drawn-in air flowing from the inlets 221 and 222. As the drawn-in air flows simultaneously via the two inlets 221 and 222 into the dust receptacle 100, it flows in at a constant rotating speed along a tangential direction of the dust receptacle 100 due to the guides 231 and 232.

Here, in comparison with a conventional dust collecting apparatus having one inlet, the dust collecting apparatus according to an exemplary embodiment of the present invention divides inflow directions of the drawn-in air into two ways to distribute an inflow pressure of the drawn-in air. Accordingly, a pressure loss can be reduced when the drawn-in air flowing into the dust receptacle 100 collides with an inner wall of the dust receptacle 100.

Furthermore, since the drawn-in air flows into the dust receptacle 100 simultaneously from two directions, dust included in the drawn-in air flow from two directions simultaneously into the dust receptacle 100. Accordingly, a separation efficiency of dust can be enhanced in comparison with a conventional dust receptacle having one inlet.

In the present embodiment, the inlets are exemplified as two. However, this should not be considered as limiting. The inlets can be provided with more than two. If the inlets are provided with more than two, the inlets may be arranged at the same angles one another based on a center of the suction passage 210. If more than two inlets are provided, a distribution efficiency of dust can be more enhanced and a pressure loss in the dust receptacle can be more reduced.

Under the guides 231 and 232, a grille part 240 is formed to filter air separated from dust. The grille part 240 has therein a space part 241 (refer to FIG. 2) disposed between the grille part 240 and an outer circumference surface of the suction passage 210. The space part 241 is in fluid communication with a pair of discharge passages 251 and 252, which will be explained later. Air passing the grille part 240 flows through the space part 241 and is directly discharged through the discharge passages 251 and 252.

A skirt 260 having a predetermined width is detachably formed along a lower end of the grille part 240. The skirt 260 has a diameter little smaller than an inner circumferential surface of the dust receptacle 100 so as to prevent dust collected on a lower portion of the dust receptacle 100 from ascending again and discharging through the grille part 240 to the outside.

The operations and effects of a dust collecting apparatus of a vacuum cleaner according to an exemplary embodiment of the present invention will be now explained.

First, as dust-laden air is drawn in via the suction passage 210 from a cleaning surface by a vacuum source (not shown), the drawn-in air flows upwardly along the suction passage 210 as shown in FIG. 2. After arriving at an upper end of the suction passage 210, the drawn-in air flows via the inlets 221 and 222, which are formed oppositely to each other, in directions A and B into the dust receptacle 100 (refer to FIG. 1).

As spirally rotated by the guides 231 and 232, the drawn-in air flows in the dust receptacle 100 gains a centrifugal force. The drawn-in air is rotated at a constant rotating force in the dust receptacle 100 to be separated from dust.

Since the drawn-in air continuously maintains a constant rotating speed, dust can be in prevented from flowing toward the grille part 240 or drawing via the grille part 240 into the discharge passage 251.

The dust separated from the drawn-in air flows along the inner wall of the dust receptacle 100 and passes a space between the dust receptacle 100 and an outer circumferential end of the skirt 260 to fall toward a lower portion of the dust receptacle 100. The collected dust is prevented from ascending again by the skirt 260.

As shown in FIG. 2, air separated from the dust flows via the grille part 240 into the discharge passages 251 and 252 and ascends along an outer circumferential surface of the suction passage 210 to flow out of the discharge passages 251 and 252 in direction C.

Air discharged from the discharge passages 251 and 252 may pass a filter (not shown) and a vacuum source such as a vacuum motor to discharge to the outside of the vacuum cleaner, or flow into a separate second or third cyclone (not shown) to remove fine dusts.

As described above, if a dust collecting apparatus according to an exemplary embodiment of the present invention is applied, drawn-in air flows into a dust receptacle via a plurality of inlets. Accordingly, a loss of pressure can be reduced in the dust receptacle and a suction efficiency can be enhanced. Additionally, dusts flowing into the dust receptacle can be distributed in various directions so that separation of dust can be enhanced.

Furthermore, sensory noise of airflow can be reduced in comparison with a conventional dust collecting apparatus having a single inlet.

Additional advantages, objects, and features of the embodiments of the invention will be set forth in part in the description which follows and in part will become apparent to those having ordinary skill in the art upon examination of the following, or may be learned from practice of the invention. The objects and advantages of the embodiments of the invention may be realized and attained as particularly pointed out in the appended claims.

What is claimed is:

1. A dust collecting apparatus for installation into a vacuum cleaner to centrifugally separate dust from drawn-in air, the apparatus comprising:
a dust receptacle to collect the dust; and
a cyclone part inserted in the dust receptacle,
wherein the cyclone part guides the drawn-in air vertically through a center of the cyclone part, allows the drawn-in air to flow in a tangential direction inside of the dust receptacle simultaneously from a plurality of directions into the dust receptacle, centrifugally separates the dust from the drawn-in air, and discharges the drawn-in air along the center.

2. The apparatus as claimed in claim 1, wherein the cyclone part comprises:
a suction passage vertically penetrating a lower portion of the dust receptacle to guide air drawn in via a suction nozzle of the vacuum cleaner from the lower portion to an upper portion;
a plurality of inlets disposed at an upper portion of the suction passage to guide the drawn-in air from the suction passage into the dust receptacle;
a grille part disposed to enclose the suction passage to flow in air discharged from the plurality of inlets and separated from the dust and prevent the dust from discharging; and
a discharge passage connected in fluid-communication with the grille part to guide air passing the grille part to a vacuum source.

3. The apparatus as claimed in claim 2, wherein the plurality of inlets are arranged at same angles based on the center of the suction passage.

4. The apparatus as claimed in claim 2, wherein the cyclone part further comprises a plurality of guides spirally extended from each of leading ends of the plurality of inlets, respectively.

5. The apparatus as claimed in claim 4, wherein the plurality of guides are downwardly formed from one side to the other side of each inlet.

6. The apparatus as claimed in claim 1, further comprising a skirt formed along a lower end of the grille part to prevent the dust collected in the dust receptacle from re-ascending.

7. A dust collecting apparatus for installation into a vacuum cleaner, comprising:
a dust receptacle; and
a cyclone part detachably inserted in the dust receptacle, the cyclone part comprising:
a suction passage connectable to a suction nozzle of the vacuum cleaner so as to guide the drawn-in air into the suction passage vertically through a lower portion of the dust receptacle,
at least two inlets at an upper end of the suction passage, the at least two inlets being formed perpendicularly to the suction passage so that the drawn-in air is distributed between the at least two inlets and flows radially outward into the dust receptacle,
a guide spirally extending from the cyclone part at each of the at least two inlets, the guide exerting a centrifugal force to the drawn-in air to centrifugally separate dust from the drawn in air, and
a space part disposed under the guide at an outer circumference surface of the suction passage, the space part being in fluid communication with a pair of discharge passages at an upper portion of the dust receptacle.

8. The apparatus as claimed in claim 7, further comprising a grill part between the guide part and the space part to filter dust from the drawn-in air.

9. The apparatus as claimed in claim 8, further comprising a skirt formed along a lower end of the grille part, the skirt having an outer diameter smaller than an inner diameter of the dust receptacle to form a space therebetween.

10. The apparatus as claimed in claim 7, wherein the at least two inlets comprises two inlets formed oppositely to each other.

11. The apparatus as claimed in claim 7, wherein the at least two inlets comprises more than two inlets arranged at the same angles with respect to one another based on a center of the suction passage.
